(19) United States
(12) Patent Application Publication
(10) Pub. No.: US 2011/0012751 A1
(43) Pub. Date: Jan. 20, 2011

(54) MESSAGE BOARD SYSTEM AND METHOD

(76) Inventor: Ken Jones, Bedias, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 12/505,951

(22) Filed: Jul. 20, 2009

(51) Int. Cl. G08C 19/00; G09F 7/00; H01R 11/00; G06F 15/16

(52) U.S. Cl. 340/825.69; 370/329; 40/612; 439/502; 709/230

(57) ABSTRACT

Provided is a messaging system that includes a highway message sign system. The message sign system includes a wireless cellular router having an Ethernet port and a serial port and being capable of communicating with a cellular wireless communication network. The message system also includes a camera coupled to the Ethernet port of the cellular router and a message sign. The message sign includes a message display and a message sign controller coupled to the serial port of the cellular router. The message sign controller is able to control operation of the message sign. Further provided is a method of operating message sign remote controller. The method includes receiving a request to communicate with a message sign system, executing an initialization file configured to initialize a communication port redirect, executing an initialization file configured to account for transmission latencies associated with use of the communication port redirect, generating a serial communication configured control operation of a message sign system, routing a serial communication from a message control application to the communication port redirect, converting the serial communication to an other communication protocol message receivable by a wireless cellular network, and routing the other communication to the message sign system via the wireless cellular network.

### BACKGROUND

1. Field of the Invention

The present invention generally relates to a system and method for operating message signs and more particularly to wireless control and operation of message signs, such as portable message signs used to alert motorist of traffic conditions.

2. Description of Related Art

Transportation systems, such as highways and other public thoroughfares, are often subject to disruptions and congestion due to construction, accidents, and natural disasters. During these disruptions, traffic is often redirected into alternate lanes or routed around an obstruction. In the case of a natural disaster, highway configurations can even be altered to help evacuate a large number of people with minimal delay and the configurations reversed to reduce delays upon those people's return. To alleviate congestion and delays associated with traffic disruptions and changes in highway configurations, alert systems have been developed to inform motorists well in advance of the expected disruption. These systems typically include temporary signs, controllable traffic signals, and variable message boards or signs (VMS). Temporary signs often include a board displaying a fixed or static message that does not change. Controllable traffic signals typically include lights or similar signaling devices programmed to run a certain routine or controlled by an operator on the scene or remotely. VMS's typically include electronic message displays or screens that are programmed to display a fixed or variable message that is informative to motorists. The message often includes a textual message, a symbol, or the like that is flashed, scrolled, or otherwise displayed to attract motorist attention. VMS's are useful because they allow for preprogrammed and custom messages. Some VMS's are accessed and controlled onsite, while others may be accessed remotely to control operation of the VMS, including control of the displayed message.

In addition to message systems that provide information to motorist, traffic monitoring systems may provide feedback to transportation agencies. Monitoring systems often include cameras or similar devices that are used record or transmit images or other information. Typically, the images may be reviewed at a later time or reviewed in real-time to determine how traffic is flowing, whether a traffic issue has arisen, or if action is needed to alleviate a traffic issue. Similar to VMS's, some cameras are accessed and controlled onsite, while others may be accessed and controlled remotely.

To provide an increased level of function and flexibility, traffic systems often include a combination of messaging and monitoring systems. For example, a VMS may include messaging boards and cameras, such that messages can be communicated and traffic can be monitored and via a single unit. In the instance both the monitoring system and the alert system can be controlled remotely, a remote operator can both monitor traffic change the displayed message if needed.

Although remotely controlled systems are beneficial, there may be significant cost associated with their operation. For example, a wireless service provider may charge subscribers an access fee to provide wireless communication between a control location and the VMS being controlled. Where several components, such as a messaging system and a camera system, of the VMS require separate wireless connections the number and amount of wireless fees can increase dramatically driving up the cost of operation. Moreover, when a large number of signs are in operation, the operating cost associated with subscribing to a wireless service provider is of increasing concern.

Accordingly, it desirable to provide messaging boards, such as VMS's that can provide an increased amount of functionality while having a reduced operating cost.

### SUMMARY

Various embodiments of messaging systems and related apparatus, and methods of operating the same are described. In one embodiment, provided is a messaging system that includes a highway message sign system. The message sign system includes a wireless cellular router having an Ethernet port and a serial port and being capable of communicating with a cellular wireless communication network. The message system also includes a camera coupled to the Ethernet port of the cellular router and a message sign. The message sign includes a message display and a message sign controller coupled to the serial port of the cellular router. The message sign controller is able to control operation of the message sign.

In another embodiment, provided is a portable message sign retrofit kit. The kit includes a wireless cellular router having an Ethernet port and a serial port and can be used to communicate with a cellular wireless communication network The Ethernet port is can be connected to a message sign controller. The kit also includes an Internet Protocol enabled camera that can be coupled to the Ethernet port of the cellular router; and a cable that can be used to connect between the message sign controller and the serial port of the cellular router.

In another embodiment, provided is a method of operating message sign remote controller. The method includes receiving a request to communicate with a message sign system, executing an initialization file configured to initialize a communication port redirect, executing an initialization file configured to account for transmission latencies associated with use of the communication port redirect, generating a serial communication configured control operation of a message sign system, routing a serial communication from a message control application to the communication port redirect, converting the serial communication to an other communication protocol message receivable by a wireless cellular network, and routing the other communication to the message sign system via the wireless cellular network.

### BRIEF DESCRIPTION OF THE DRAWINGS

Advantages of the present invention will become apparent to those skilled in the art with the benefit of the following detailed description and upon reference to the accompanying drawings in which:

FIG. 1 is an illustration of a messaging sign system in accordance with one or more embodiments of the present technique;

FIG. 2 is a schematic diagram that illustrates a messaging system in accordance with one or more embodiments of the present technique;

FIG. 3 is a schematic diagram of the message sign system in accordance with one or more embodiments of the present technique;

FIG. 4 is a schematic diagram that illustrates a remote controller system in accordance with one or more embodiments of the present technique;

FIG. 5 depicts a portion of an information file in accordance with one or more embodiments of the present technique; and

FIGS. 6A-6D illustrate a cable in accordance with one or more embodiments of the present technique.

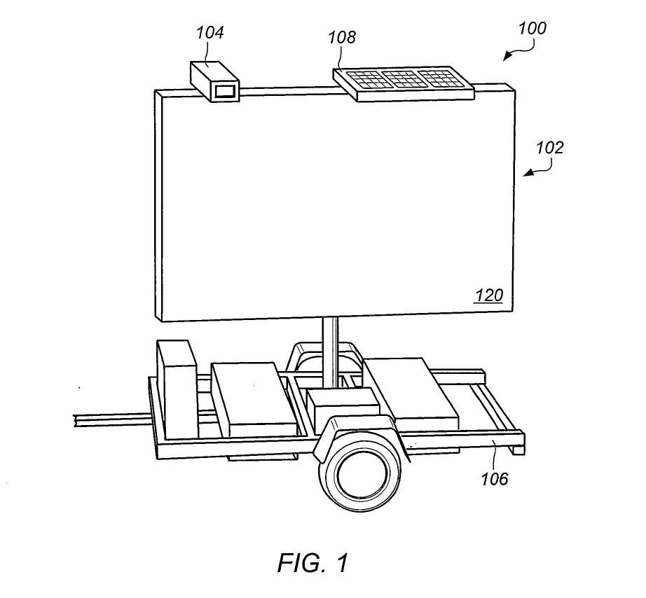

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF ILLUSTRATIVE EMBODIMENTS

As discussed in more detail below, certain embodiments of the present technique include a system and method for monitoring traffic conditions and providing messages to motorists. In some embodiments, a messaging system includes a messaging sign and a remote controller that communicates with the messaging sign. The remote controller in some embodiments can be used to operate the message sign. In some embodiments, the remote controller can be used to receive data, such as images sent from a camera mounted on the messaging sign. Wireless communication between the remote controller and the messaging sign system is provided via a wireless cellular network, in some embodiments.

In certain embodiments, an output of software applications run on the remote controller is redirected from a serial output port to another port, such as an Ethernet port accessible, via a communication port redirect. In certain embodiments, an output of the Ethernet port is connected to a wireless network provider such that the software application can communicate via the internet and/or a wireless cellular network. In some embodiments, the communication port redirect converts application output from one communication protocol (e.g., a serial protocol output intended to be transmitted via a serial bus) to another communication protocol suitable for transmission receipt and/or transmission via the wireless cellular network (e.g., transmission control protocol/internet protocol (TCP/IP)). In certain embodiments, the message sign system includes a router, such as a wireless cellular router, that is capable of communicating via the wireless cellular network. In some embodiments, the wireless cellular router includes a cellular 3G router having an Ethernet port a serial port that can be connected to a camera and controller, respectively, of the message sign. In some embodiments, a custom cable is used to connect a serial port of the wireless cellular router to a controller of the message sing system. The cable, in some embodiments, includes a specific pin-out configured to support communication between the router and the controller.

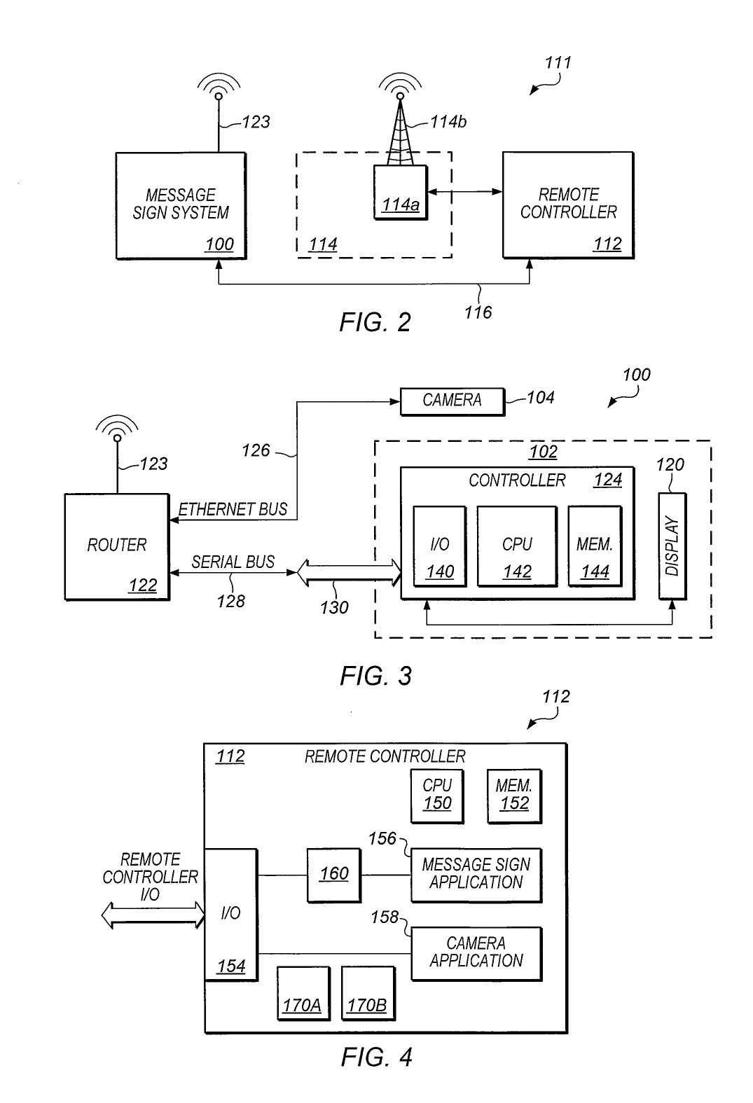

Turning now to FIG. 2, depicted is a messaging sign system 100 in accordance with one or more embodiments of the present technique. In the illustrated embodiment, messaging sign system 100 includes input/output (I/O) devices, such as a messaging sign 102 and a camera 104. In the illustrated embodiment, messaging sign system 100 also includes a frame 106 and power supply 108. Frame 106 includes a trailer that enables messaging sign system 100 to be easily transported from one location to another. For example, frame 106 may include wheels, tires, and a hitch that allow a vehicle to tow the sign from one location to another. In other embodiments, frame 106 may include a skid, sled, or similar structural support that is portable or substantially fixed. Frame 106 can also provide a structural base for mounting of components, including messaging sign 102, camera 104, and power supply 108. Frame 106, in one embodiment, includes a rigid structure that is capable of supporting devices mounted thereon. In one embodiment, frame 106 is constructed of a metal or a similar rigid material. In the illustrated embodiment, power supply 108 includes solar panels that are used to charge batteries capable of powering messaging sign system 100. In other embodiments, power supply 108 may include a cabled connection to a power grid, additional batteries, a fuel cell, wind turbine, or the like. The combination of one or more of these types of power sources may further improve the performance and portability of messaging sign system 100.

Messaging sign 102 includes a display 120 that can be used to post messages. Messages displayed may include fixed or variable message that are informative to motorists or similar audiences. The messages may include a textual message, a symbol, or the like that is flashed, scrolled, or otherwise displayed to attract motorist attention, or any combination thereof.

In one embodiment, display includes a matrix of light emitting diodes (LED's), a liquid crystal display (LCD), or the like. In one embodiment, display 120 includes a single panel such as the depicted rectangular shape display panel. In other embodiments, a plurality of panels may be used to form display 120. For example, panel may be formed from two or more rectangular display panels that are positioned adjacent one another to form display 120.

In the illustrated embodiment, display 120 includes a rectangular frame substantially surrounding an exterior of display 120. The frame provides support and defines an internal region of messaging sign 102 that is located behind display 120. In one embodiment, a portion of display 120 is removable to enable access to the internal region and components of messaging sign system 100 housed therein. For example, in one embodiment, one of a plurality of panels forming display 120, or a portion of display 120, can be removed to provide access to components housed therein (e.g., behind display 120). The components may include controllers, cabling, batteries, or the like. Other embodiments may include an access hatch located in a side of messaging sign 102 opposite display 120, located in frame 106, or in any suitable location to provide access to internal components of display 120 and or messaging sign system 100.

Display 120 may be fixed or movable. For example, in one embodiment, display 120 may be rigidly fixed such that it remains substantially fixed relative to frame 106 resulting in little or no movement of display 120. In other embodiments, display 120 may be movable between multiple positions to enable the position and direction of the displayed message to be modified. For example, display 120 may tilt, swivel, raise and lower relative to frame 106 and/or other components of messaging system 100. In one embodiment, display 120 is coupled to a telescoping pole such that the display can be raised to provide motorist with an elevated viewing angle.

Camera 104 includes a device capable of capturing images and storing and/or transmitting them for review. In one embodiment, camera 104 includes a camera capable of capturing color images, black and white images, thermal images, and/or infrared images. In one embodiment, camera 104 is capable of capturing continuous video images, time lapse video images, and/or still images. Further, camera 104 may be capable of receiving audio (e.g., one-way radio) and/or transmitting audio to and from camera 104 (e.g., two-way audio). Camera 104 may operate on power supplied from its own battery or power system, or may receive power via power supply 108 of messaging sign system 100.

In one embodiment, camera 104 includes a camera capable of communicating over the internet. Camera 104 may include a port capable of connecting directly with an Ethernet cable and or a complementary port of a router, or similar wireless/internet access point. For example, camera 104 may include an IP-enabled camera, such as model DCS-3220 camera manufactured by D-Link Systems, Inc. headquartered in Fountain View, Calif. During operation, camera 104 may be powered on/off, panned, tilted, zoomed, or otherwise monitored. Operations of camera 104 may be remotely controlled and/or monitored, as discussed in more detail below.

In the illustrated embodiment, camera 104 is mounted to a top side of messaging sign 102 with its field of view directed in substantially the same direction as the display 102. This may enable camera 104 to monitor traffic as it approaches messaging sign 102. In other embodiment, camera 104 may be placed in a variety of locations and orientations. For example, camera 104 may be coupled to sides of messaging sign 102, to frame 106, and may be directed forward, to the side, or backwards to capture images in varying relations to messaging sign system 100. Moreover, an embodiment may include the addition of a mast/pole that can be used to elevate camera 104. Such an embodiment may enable a higher perspective which can increase a field of view of camera 104. Other embodiments of messaging sign system 100 may include any number of cameras 104. For example, two cameras may be employed. One camera may be directed forward such that it can capture images of oncoming, and one camera may be directed rearward such that it can capture images of departing traffic. Such options may increase the flexibility of use of messaging sign system 100.

Camera 104 may be directly coupled to components of messaging system 100 or may include a housing, or similar protective enclosure, used to house and mount camera 104 to messaging system 100. For example, in the illustrated embodiment, camera 104 is disposed within a rectangular housing that is directly coupled to a frame of messaging sign 102. The housing may include an integral housing of camera 104, or may include a separate housing that camera 104 can be installed into or removed from. The housing may provide protection for camera 104 and its associated electronics while enabling camera 104 to maintain an effective viewpoint. Moreover, the housing may enable easy exchange of camera 104 in the event it needs to be serviced or replaced. In the illustrated embodiment, camera 104 is situated within the housing such that its lens is directed toward a transparent window or opening of the housing. In one embodiment, the housing may include a hemi-spherical shaped transparent window that enables camera 104 to be directed in various orientations to capture different views.

Camera 104 may be fixed or may be capable of articulating between multiple positions. For example, in one embodiment, camera 104 may be rigidly fixed and directed toward oncoming traffic. Articulation of camera 104 may include panning, tilting, zooming, or the like. In one embodiment articulation of camera 104 can be controlled remotely, such as through wireless communication, as discussed in more detail below.

Other embodiments of message sign system 100 may include any number of additional devices. For example, message sign system 100 may include radar units (such as those used to monitor motorists speed), weather instrumentation, environmental instrumentation, and the like. Radar units may be used to detect an approaching motorist's speed. Weather instrumentation may include temperature thermometers, rain gauges, barometers or the like that are configured to collect weather information. Environmental instrumentation may include ozone sensors, or similar devices used to gather relevant environmental information, such as pollution data. In one embodiment, the collected information may be stored, displayed or transmitted to a remote location through wired or wireless communication, as discussed in more detail below.

In one embodiment, messaging sign system 100 includes a commercially available portable message sign system, such as that manufactured by American Signal Company, headquartered in Atlanta, Georgia. For example, message sign system 100 may include one of American Signal Company model CMS-T333, T331, T332, or similar. The CMS-T333 is a portable changeable message sign that is a full size, all LED, solar charged, programmable, full matrix changeable message sign capable of displaying alphanumeric messages in nine font sizes, and displaying Mutual Uniform Traffic Control Devices (MUTCD) Part VI graphic construction signs and arrow board messages. The CMS-T333 model sign is capable of displaying messages with legibility distances of approximately one thousand feet (1000) and features automatic centering capability for each line of a displayed message. The CMS-T333 model sign may be equipped for remote operation and may be interfaced with an optional radar transmitter and display actual speeds for vehicles exceeding the user selectable “threshold” speed. The CMS-T333 model is suited for construction and maintenance work zone applications on high capacity, high speed roadways requiring extended visibility and legibility distances.

FIG. 2 is a schematic diagram that illustrates a messaging system 111 including message sign system 100, in accordance with one or more embodiments of the present technique. More specifically, messaging system 111 includes message sign system 100 and a remote controller system 112. As described above, message sign system 100 may be operated to communicate information to and from motorist and remote locations. For example, messaging system 111 may displaying message on display 120 and/or capture and transmit images via camera 120. The illustrated embodiment also includes a wireless cellular network 114 in communication with remote controller 112. The illustrated embodiment also includes a hardwired connection 116 between remote controller 114 and message sign system 116. Each of the wireless cellular network 114 and the hardwired connection may facilitate communication between message sign system 110 and remote controller 112.

In one embodiment, one or both of the wireless and hardwired connections may be used to communicate information between remote controller 112 and message sign system 100. For example, where wireless communication is used, remote controller 112 may transmit information to a wireless cellular network 114 for distribution. In one embodiment, information is received at a terminal 114a of wireless network 114 and broadcast via a wireless transmitter/receiver 114b, such as a cellular communications tower. The broadcast information may be received at an antenna 123 of message sign system 100. Wireless communication from message sign system 100 to remote controller 112 may be accomplished in a reverse manner. For example, message sign system 100 may broadcast information via antenna 123. The broadcast information may be received wireless transmitter/receiver 114b and terminal 114a, and routed to remote controller 112. Where a direct connection is used, such as a cabled connection between remote controller 112 and message sign system 100, information may be transmitted via a wired communication protocol, such as serial communication. For example, where remote controller 112 includes a portable computer (e.g., a laptop computer), a cable can connect a control port of a message sign system 100 and a communication port of remote controller 112 directly to one another. Such a direct connection may be practical where an operator is on-site or near by message sign system 100, but may be less practical in other circumstances (e.g., when there is a significant distance between message sign 100 and remote controller 112). An embodiment may include a combination of wired and wireless communication.

FIG. 3 is a schematic diagram of messaging sign system 100 in accordance with one or more embodiments of the present technique. In the illustrated embodiment, messaging sign system 100 includes messaging sign 102, camera 104, and a router 122. Messaging sign 102 and camera 104 may communicate wirelessly via router 122. For example, information transmitted and received by messaging sign 102 and camera 104 may be transmitted over a wireless network 114 via router 122.

In the illustrated embodiment, message sign 102 includes controller 124 and display 120. In the illustrated embodiment, controller 124 includes input/output (I/O) 140, a central processing unit (CPU) 142 and memory 144. I/O 140 may include one or more communication ports, such as serial ports, PCI local ports, Ethernets ports, and/or USB ports. I/O 140 may also include an input (e.g., a plug) for direct connection of remote controller 112 to message sign system 100 via hardwired connection 116 (See FIG. 2). CPU 142 may include a computer processor or similar logic device configured to execute routines used in the operation of messaging sign 102. Memory 144 may include a system memory of messaging sign 102 and/or an external memory. For example, memory 144 may include a hard-disk memory, random access memory (RAM), flash memory, CD-ROM, a floppy disk, or the like. Memory 144 may include a computer storage medium having, or configured to have, program instruction stored thereon. The program instructions may be capable of implementing one or more method steps executable by CPU 142 and/or other components of message sign 102. For instance, message sign 102 may include a message sign operation application stored on memory 144. Message sign operation application may include applications to control various functionality and operations of message sign 102 or other devices of messaging sing system 100. Further, message sign operation applications may include functionality to facilitate communication with remote controller 112.

Controller 124 may include a proprietary controller provided as an integral part of sign 102 in one embodiment. A proprietary controller may include hardware and software specifically designed for use with control certain types of messaging sign systems. Further, a proprietary controller may communicate and otherwise be controlled by a unique set of commands, a unique implementation of a communication protocol, or the like. Accordingly, a proprietary controller may communicate with a proprietary message sign control application, as described in more detail below with respect to FIG. 4. Controller 124 may be manufactured by American Signal Company, headquartered in Atlanta, Georgia, and configured to communicate with controllers used in messaging signs manufactured by American Signal Company.

In an embodiment, router 122 may broadcast and/or receive communications via antenna 123. In one embodiment, antenna 123 includes an antenna integral to router 122. In one embodiment, antenna 123 includes an external antenna (e.g., magnetic 9 Db gain antenna).

In one embodiment, router 122 is used to send and receive wireless communications via wireless cellular network 114. For example, router 122 may include a cellular “3G” router that is compatible for use on various cellular networks. Router 122 may be configured to communicate via various communication protocols, such as UDP/TCP, DCHP, and the like. Router 122 may also include one or more ports that can be used to communicate with other components of messaging sign system 100, such as message sign 102 and camera 104. For example, router 122 may include one or more Ethernet ports and one or more serial ports. In one embodiment, router 122 is a ConnectPort WAN VPN Modem manufactured by Digi International, headquartered in Minnetonka, Minn.

In the illustrated embodiment, router 122 communicates with camera 104 via an Ethernet bus 126. In one embodiment, Ethernet bus 126 includes a local area network (LAN) cable coupled from an Ethernet port of router 122 to an Ethernet port of camera 104. Communication between router 122 and camera 104 may be provided via TCP/IP communication protocol.

In the illustrated embodiments, router 122 communicates with message sign 102 via serial bus 126. In one embodiment, serial bus 126 includes a serial cable 130 coupled between a serial port of router 122 and a serial port of message sign 100. Communication between router 122 and message sign 102 may be provided via serial communication protocol. In one embodiment, serial cable 130 includes a pin-out typically associated with a standard serial cable interface. For example, cable 130 may include a DB9 and/or a DB25 connector at each end wired for RS232, RS422, RS423 or RS485 type serial communication.

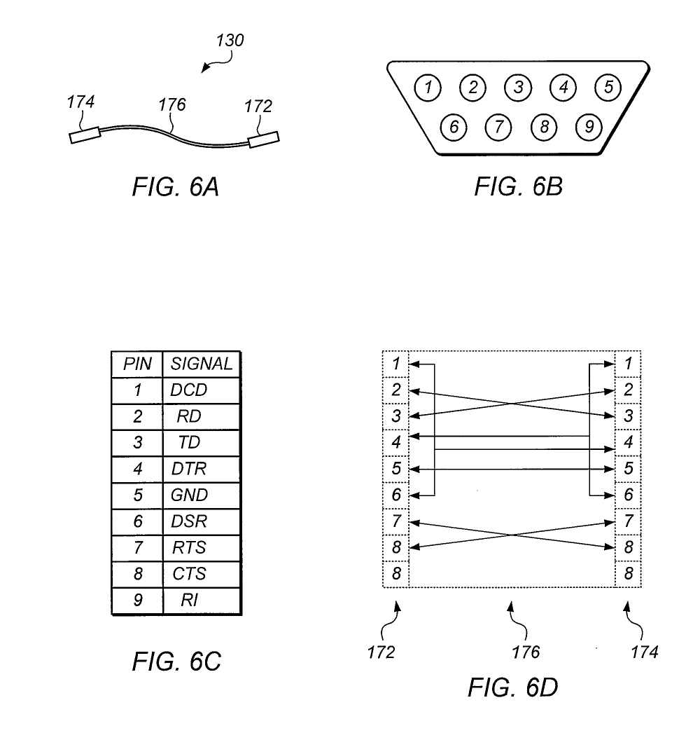

In one embodiment, a custom cable is employed to account for various hardware and software configurations. For example, where message sign 102 communicates via a proprietary protocol (e.g., a proprietary control application), cable 130 may include a specific pin-out for appropriately routing signals. FIGS. 6A-6D illustrate cable 130 in accordance with one or more embodiments of the preset technique. FIG. 6A depicts a first connector 172 coupled to a second connector 174 via cable 176. Connectors 172 and 174 include DB9 connectors in the illustrated embodiment. Cable 176 includes a nine-wire cable, such as a cable typically used with serial communication cables. In the illustrated embodiment, connectors 172 and 174 of cable 130 each include a nine-pin “D-SUB” or “DB9” connector, such as that depicted in FIGS. 6B, having given signal connections, such as those depicted in FIG. 6C. FIG. 6D depicts a pin-out of cable 130 in accordance with one embodiment. In the illustrated embodiment, pin 1 (DCD) and pin 6 (DSR) of each connector are connected to pin 4 (DTR) of the other connector, pin 2 (RD) of each connector is coupled to pin 3 (TD) of the other connector, pin 5 (GND) of each connector is coupled to pin 5 (GND) of the other connector and pin 7 (RTS) of each connector is coupled to pin 8 (CTS) of the other connector. Other cable configurations, including different connectors and pin-outs may be used, depending on the specific application.

FIG. 4 is a schematic diagram that illustrates remote controller system 112 in accordance with one or more embodiments of the present technique. Remote controller may include a computing device, such as a personal computer (“PC”), a portable computing device (e.g., a laptop or handheld computer), or the like. In the illustrated embodiment, remote controller system 112 includes a central processing unit (CPU) 150, a memory 152, and input/output ports 154. CPU 152 may include a computer processor or similar logic device configured to execute routines used to operate remote controller system 112. Memory 152 may include a system memory of remote controller system 112 and/or an external memory. For example, memory 152 may include a hard-disk memory, random access memory (RAM), flash memory, CD-ROM, a floppy disk, or the like. Memory 152 may include a computer storage medium having, or configured to have, program instruction stored thereon to implement one or method steps executable by CPU 150 and or other components of remote controller system 112. Message sign control application 156 and/or camera application 158 may include a software application stored on memory 152 of remote controller 112. For instance, in the illustrated embodiment, remote controller system 112 may include message sign control application 156 and a camera application 158 stored on memory 152. Each of the applications may be used alone or in combination to communicate with message sign system 100. In one embodiment, remote controller 112 may access or have stored on a memory thereof, a host configuration information file 170A and/or a host configuration initialization file 170B. Each of these files 170A and 170B may be created, modified, and/or executed in accordance with one or more embodiments described herein.

In one embodiment, message sign application 156 includes software that can be used to communicate with message sign system 100 and to control operation of message sign 102 and/or other components of message sign system 100. For example, message sign application 156 may be used to control a message displayed on display 120, to power message sign system 100 on and off, to detect errors in operation of messaging sign system 100, to initiate and run diagnostics on messaging sign system 100, or similar functions.

In one embodiment, sign control application 156 includes universal or proprietary application software provided by the sign system manufacturer. Universal software may include an at least substantially universal software application that can be used to control different message sign systems with a common software application and/or commands. For example, universal software may include commands in accordance with a common communication protocol designed for use with messaging sign systems. Proprietary application software may implement a unique set of commands, a unique implementation of a communication protocol, or the like used to communicate with a specific model, brand, and/or type of complementary controller (e.g., controller 124 of messaging sign 102 depicted in FIG. 3). In one embodiment, message sign control application 156 includes “Easy Host” software provided by American Signal Company, headquartered in Atlanta, Ga., and configured to communicate with controllers used in messaging signs manufactured by American Signal Company, such as controllers of American Signal Company CMS-T333, T331 and/or T332, or similar model messaging signs.

Camera application 158 may include software that can be used to communicate with camera 104 and used to control operation of camera 104 and/or other components of message sign system 100. For example, camera application 158 may be used control imaging by camera 104, to control pan, tilt and zoom of camera 104, to turn camera 104 on and off, to detect errors in operation of camera 104, to initiate and run diagnostics on camera 104, or similar functions.

In one embodiment, camera application 158 includes web-based software that can be accessed and run via an internet browser. For example, camera 158 can be accessed from almost any computer by opening an internet browser and navigating to a web-page associated with camera 104 to view images or otherwise control operation of camera 104. In one embodiment, camera application 158 includes universal application software or proprietary application software provided by the camera manufacturer. Universal software may include an at least substantially universal software application that can be used to control different camera systems with a common software application and/or commands. Universal software may include commands in accordance with a common communication protocol designed for use with camera systems. For example, camera 104 and camera application 158 may adhere to Universal Plug and Play (UPnP) specification that enables certain computers to automatically recognize and/or control camera 104. Proprietary application software may include software specifically designed for use with control certain types of cameras. Proprietary application software may implement a unique set of commands, a unique implementation of a communication protocol, or the like that is designed to communicate with a specific model, brand, and/or type of camera. In one embodiment, camera application 158 includes software provided by D-Link Systems, Inc. headquartered in Fountain View, Calif., and configured to communicate with cameras manufactured by D-Link Systems, Inc.

Message sign application 156 and/or camera application 158 may each be executed to provide communication via one or more input/output devices 154 of remote controller 112. For example, message sign application 156 and/or camera application 158 may communicate via a serial port, a universal serial bus (USB) port, a PCI Local Bus (PCI Bus), an Ethernet port, and/or similar communication interface. Communication via each of these interfaces may include transmitting signals and information in accordance with each respective communication protocols. For example a serial communication protocol may be employed to communicate via the serial port, and TCP/IP may be employed to communicate via the Ethernet port. In one embodiment, I/O of remote controller is transmitted via a wireless communication technique (e.g., via wireless network 114), via a hardwired connection (e.g., hardwire 116), or a combination thereof. Remote controller 112 may employ message sign application software, camera application software, or other application software that communicates with message sign system 100 as described above with respect to FIG. 2.

In one embodiment, application software may be designed to communicate via a specific protocol, although communication via another protocol is desired. In such an instance, it may be desirable to translate/convert from one protocol to another such that the desired method of communication and application software can function cohesively. For example, in one embodiment, message sign application 156 includes a software application that is designed to communicate with a controller via a serial communication protocol. Although this may not be an issue where a hardwire connection exists, such as a connection between remote controller 112 and message sign system 100 via serial cable, an issue may arise where communication between remote controller 112 and message sign system 100 is achieved via one or more different protocols. For example, in an embodiment that includes wireless communication between remote controller 112 and message sign 100 via a wireless network 114, a different communication protocol may be used. In one embodiment, for instance, wireless network 114 includes an internet service provider terminal and/or a cellular wireless transmitter/receiver that communicates with message sign system 100. Such communication may include using a wireless communication protocol and/or a communication protocol suitable for routing information to the terminal. For instance, in one embodiment, the wireless service provider terminal may be accessed via the internet and/or a TCP/IP protocol. In one embodiment, for instance, remote controller 112 is connected to the wireless network 114 and communicates via TCP/IP protocol. In such an embodiment, a communication port redirect may be used to convert and/or route communications from message sign control application to an appropriate I/O port used to communicate with wireless network 114. For example, a communication port redirect may be used to convert/redirect serial communications of message sign application to/from an Ethernet port of remote controller 112.

FIG. 3 depicts a communication (COMM) port redirect 160 disposed between message sign application and I/O 154. In one embodiment, communication port redirect 160 is employed to convert serial communications generated by message sign application 112 to TCP/IP communications that are routed (e.g., via Ethernet port of I/O 154) to the internet and/or wireless network 114. Communication port redirect 160 can also be employed to convert TCP/IP communications received at I/O 112 (e.g., via Ethernet port of I/O 154, the internet and/or wireless network 114) to serial communications that can be routed for receipt by message sign application 156.

In one embodiment, communication port redirect 160 includes a software application that is implemented to redirect and/or convert communications between two protocols, such as serial and TCP/IP. Communication port redirector 160, in one embodiment, creates virtual COMM ports and software modems for modem applications (e.g., application using serial communication) to use TCP/IP networks (e.g., the internet) instead of modem hardware and telephone connections. Communication port redirect 160 may include COM/IP COM Port Redirector provided by Tactical Software LLC, headquartered in Bedford, N.H. Other embodiments may include one or more communication port redirects to convert communication from one or more other applications to a given communication protocol. For example, in an embodiment in which camera application 158 communicates via serial communication, a communication port redirect may be used in a similar manner between camera application 158 and I/O 154 of remote controller 112.

In one embodiment, additional modifications may be provided to enable or improve communication between applications, communication port redirect 160 and/or I/O 154. For example, certain files may need to be modified to enable message sign application 156 and/or camera application 158 to operate properly with communication port redirect 160 and/or I/O 154. In one embodiment, a windows host configuration information file and/or an initialization file of message sign application 156 is modified to enable the application to appropriately communicate with communication port redirect 160. For example, an initialization string of the initialization file may be modified such that message sign control application 156 initiates communication with a port (e.g., a virtual port) associated with communication port redirect 160. In one embodiment, modifying the initialization file includes modifying at least a portion of the code to direct communication to the COM redirect 160 as opposed to a serial port.

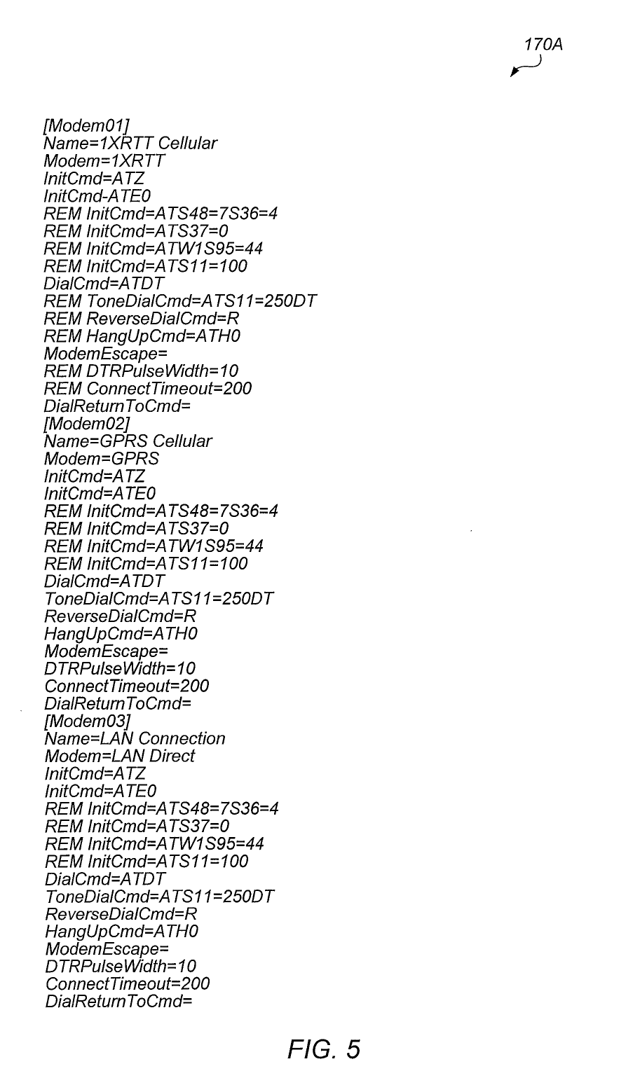

FIG. 5 illustrates a portion of windows host configuration information file 170A (e.g., “wcmshost.inf”) in accordance with one or more embodiments of the present technique. In the illustrated embodiment, the host initialization is modified to reconfigure certain connection types to remove certain elements and streamline commands. In the illustrated embodiment, three distinct connection types are reconfigured using “REM” programming language construct/syntax. Configuration information file 170A has been modified to allow connection over various service providers using a COM Port Redirector (e.g., Tactical Software COM/IP COM Port Redirector. In one embodiment, configuration information file 170A may be created or modified based on an existing file. Although the illustrated embodiment includes a specific set of values, other values may be used to fine tune operation of the respective application and configuration information file 170A in messaging system 111.

In one embodiment a portion of windows host configuration initialization file 170B (e.g., “wcmshost.ini”) is created/modified in accordance with one or more embodiments of the present technique. In one embodiment, the host configuration initialization file 170B is modified to reconfigure (e.g., modifying or adding) certain connections of message sign application 156. In one embodiment, host configuration initialization file 170B is modified in advance of using message sign application 156. For example, host configuration file may be used where an installer knows variables such as IP address, port number, and sign ID for use with one or more message sing systems 100. In one embodiment, each message sign system 100 may be associated with a unique identifier. In one embodiment, the unique identifier (e.g., identification number) is hard encoded into host configuration initialization file 170B. For example, where message sign system includes a sign ID of XXX, configuration initialization file 170B may be modified to include “SignID=XXX”. The sign ID may be derived from the existing serial number hard encoded into portable message sign system 100 firmware and/or created by creating/modifying an existing ID (e.g., existing serial number hard encoded into portable message sign system 100). In one embodiment, creating/modifying an existing ID may include tethering a hand held remote controller to message sign system 100 in an administration mode and creating/modifying an ID.

In one embodiment, windows host configuration initialization file 170B (e.g., “wcmshost.ini”) is created/modified such that a sign phone number (e.g., “SignPhoneNumber=”) is assigned a value. In one embodiment, the phone number is created based on an IP address and/or port number of a destination router (e.g., router 122) of message sign system 100. In one embodiment, the sign phone number is assigned/encoded to include an existing IP address and port of the router serial port. For example, where an IP address in three digit dot decimal notation is “111.222.333.444” and a five digit port number is “55555”, windows host configuration file 170B may be modified such that the sign phone number is associated with a combination of the IP address and the five digit port number. For example, windows host configuration file may be created/modified to include “SignPhoneNumber=11122233344455555” encoded therein. Although the illustrated embodiment includes a specific set of values, other values may be used to fine tune operation of the respective application and configuration information file 170B in messaging system 111.

In one embodiment, initialization file 170 may be modified to tune message sign control application 156 or camera application 158 for use. Tuning may include modifying message sign application 156 to account for latencies in the resulting system, such as those due to operation of communication redirect port 160. In one embodiment, certain values maybe set/modified to keep the network communication active using a small portion of overhead, thereby reducing the likelihood of undesired disconnections. Signal strength may be provided by use of a high gain antenna and/or adjusting TCP setting to provide a given latency. In one embodiment, the latency between transmitted and received data is below about 750 milliseconds. In on embodiment, TCP settings of remote controller 112 are set to send data only under the following conditions: (1) send after the following number of idle milliseconds (e.g., 1 ms) and (2) Send after the following number of bytes (e.g., 1500 bytes). In one embodiment, remote controller 111 is configured such that TCP connection remains active. In one embodiment, using a network application, TCP server settings for TCP sockets (e.g., that enable a serial device to communicate over a TCP network) are modified/set such that raw TCP access using a given TCP port is enabled to connect directly to a serial port using the TCP port, and the respective TCP port is set to stay active. In one embodiment, an application that may be used to enable the TCP connection to remain active on remote controller 11 includes “StayAlivePro” available online from BySoft.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. The words “include”, “including”, and “includes” mean including, but not limited to. As used herein; the singular forms “a”, “an” and “the” include plural referents unless the content clearly indicates otherwise. Thus, for example, reference to “a camera” includes a combination of two or more cameras.

What is claimed is:

1. A messaging system, comprising:
a highway message sign system, comprising:
a wireless cellular router having an Ethernet port and a serial port and configured communicate with a cellular wireless communication network;
a camera coupled to the Ethernet port of the cellular router; and
a message sign, comprising:
a message display; and
a message sign controller coupled to the serial port of the cellular router, wherein the message sign controller is configured to control operation of the message sign.

2. The messaging system of claim 1, comprising:
a highway message sign remote controller system, comprising:
an input/output port configured to communicate with the cellular wireless communication network;
a memory having a message sign control application stored thereon, wherein the message sign application that is configured to transmit message sign communications via a serial communication protocol;
a communication port redirect configured to convert message sign communications transmitted via serial communication protocol to an other communication protocol and to route message sign communications via the input/output port coupled to a cellular wireless communication network.

3. The message system of claim 2, comprising a memory having an initialization filed stored thereon, wherein the initialization file is configured to initialize the communication port redirect when message sign control application is initiated.

4. The message system of claim 2, comprising a memory having a windows host configuration initialization file stored thereon, wherein the initialization file is executed when a request to initiate message sign control application is received, and wherein the initialization file comprises an encoded identifier comprising an IP address of the message sign and an identifier of the serial port of the cellular router.

5. The message system of claim 2, wherein the input/output port is connected to the wireless communication network via the internet.

6. The message system of claim 1, wherein the other communication protocol comprises TCP/IP.

7. The message system of claim 1, wherein the cellular router comprises a 3G cellular router.

8. The message system of claim 1, wherein the cellular router is a single cellular router used to communicate with the camera and the controller.

9. The message system of claim 1, wherein a connection between the message sign controller and the serial port of the cellular router comprises a custom cable having a single DB9 connector on one configured to connect to message sign controller.

10. The message system of claim 1, wherein a connection between the message sign controller and the serial port of the cellular router comprises a cabled connection between the message sign controller and the serial port of the cellular router, the cable comprising two connectors comprising pin 1 (DCD) and pin 6 (DSR) of each connector connected to pin 4 (DTR) of the other connector, pin 2 (RD) of each connector is connected to pin 3 (TD) of the other connector, pin 5 (GND) of each connector is connected to pin 5 (GND) of the other connector and pin 7 (RTS) of each connector is coupled to pin 8 (CTS) of the other connector.

11. A portable message sign retrofit kit, comprising:
a wireless cellular router having an Ethernet port and a serial port and configured communicate with a cellular wireless communication network, wherein the Ethernet port is configured to be connected to a message sign controller;
an Internet Protocol enabled camera coupleable to the Ethernet port of the cellular router; and
a cable configured to connect between the message sign controller and the serial port of the cellular router.

12. The portable message sign retrofit kit of claim 10, wherein the cable comprises two connectors comprising pin 1 (DCD) and pin 6 (DSR) of each connector connected to pin 4 (DTR) of the other connector, pin 2 (RD) of each connector is connected to pin 3 (TD) of the other connector, pin 5 (GND) of each connector is connected to pin 5 (GND) of the other connector and pin 7 (RTS) of each connector is coupled to pin 8 (CTS) of the other connector.

13. The portable message sign retrofit kit of claim 10, comprising a memory having a communication port redirect software stored thereon, wherein the communication port redirect software is configured to route message sign communications via an input/output port of a remote controller that is in communication with a cellular wireless communication network.

14. The portable message sign retrofit kit of claim 13, wherein the communication port redirect software is configured to convert message sign communications transmitted via serial communication protocol to an other communication protocol.

15. The portable message sign retrofit kit of claim 14, wherein the communication port comprises an Ethernet port, and wherein the other communication protocol comprises TCP/IP.

16. The portable message sign retrofit kit of claim 10, comprising a memory having a windows host configuration initialization file stored thereon, wherein the initialization file is executed when a request to initiate message sign control application is received, and wherein the initialization file comprises an encoded identifier comprising an IP address of the message sign and an identifier of the serial port of the cellular router.

17. A method, comprising:
operating message sign remote controller, comprising:
receiving a request to communicate with a message sign system;
executing an initialization file configured to initialize a communication port redirect;
executing an initialization file configured to account for transmission latencies associated with use of the communication port redirect;
generating a serial communication configured control operation of a message sign system;
routing a serial communication from a message control application to the communication port redirect;
converting the serial communication to an other communication protocol message receivable by a wireless cellular network;
routing the other communication to the message sign system via the wireless cellular network.

18. The method of claim 17, comprising:
operating message sign system, comprising:
receiving, at a wireless cellular router of a message sign system, the other communication protocol message; and
routing the other communication protocol message to a controller of the message sign system.

19. The method of claim 18, wherein routing the other communication to a controller of the message sign system, comprises routing via a cable comprises two connectors comprising pin 1 (DCD) and pin 6 (DSR) of each connector connected to pin 4 (DTR) of the other connector, pin 2 (RD) of each connector is connected to pin 3 (TD) of the other connector, pin 5 (GND) of each connector is connected to pin 5 (GND) of the other connector and pin 7 (RTS) of each connector is coupled to pin 8 (CTS) of the other connector.

20. The method of claim 18, comprising communicating with a camera of the message sign system via the wireless cellular router.
